(19) United States
(12) Patent Application Publication
(10) Pub. No.: US 2022/0366261 A1
(43) Pub. Date: Nov. 17, 2022

(54) STORAGE-EFFICIENT SYSTEMS AND METHODS FOR DEEPLY EMBEDDED ON-DEVICE MACHINE LEARNING

(71) Applicant: Maxim Integrated Products, Inc., San Jose, CA (US)

(72) Inventors: Mark Alan LOVELL, Lucas, TX (US); Robert Michael MUCHSEL, Addison, TX (US); Brian Gregory RUSH, Southlake, TX (US)

(73) Assignee: Maxim Integrated Products, Inc., San Jose, CA (US)

(21) Appl. No.: 17/320,397

(22) Filed: May 14, 2021

(51) Int. Cl. G06N 3/08

(52) U.S. Cl. CPC G06N 3/084; G06N 3/082

(57) ABSTRACT

Storage-efficient, low-cost systems and methods provide embedded systems with the ability to dynamically perform on-device learning to modify or customize a trained model to improve computing and detection accuracy in small-scale devices. In certain embodiments, this is accomplished by repurposing storage elements from inference to training and performing partial back-propagation in embedded devices in the final layers of an existing network. In various embodiments replacing weights in final layers, while using hardware components to iteratively performing forward-propagation calculation, advantageously, reduces the need to store intermediate results, thus, allowing for on-device training without significantly increasing hardware requirements or requiring excessive computational memory resources when compared to conventional machine learning methods.

### BACKGROUND

### A. Technical Field

The present disclosure relates generally to on-device machine learning. More particularly, the present disclosure relates to systems and methods for reducing computational requirements in “at-the-edge” machine-learning applications.

### Background

Machine learning applications, specifically Deep Neural Network applications, have made great strides over the last decade. Machine learning is now used to solve tasks as challenging and diverse as image processing, such as face recognition tasks, and high-dimensional data interpretation, such as blood pressure trending analysis. As persons skilled in the art will understand, there are two important phases of machine learning: (1) training or learning, i.e., the use of known input data to perform computations to generate and modify model parameters and coefficients associated with a new neural network or model and its structure and connectivity, and (2) inference, i.e., the use of a previously trained model to compute a result based on new, unknown input data.

Increasingly, machine learning processes are being deployed for inference in deeply embedded systems, using custom hardware accelerators. Although acceleration for inference can thus be performed in embedded hardware, the machine learning task of training (or learning) still occurs outside of such embedded hardware. This is mainly due to the fact that commonly used devices to train a model consist of readily available high-capacity computers that oftentimes are equipped with power-hungry hardware, such as ASICs (Application-Specific Integrated Circuits) or highly parallel graphics accelerators (GPUs) that are not suitable for deployment in low-power, low-cost environments.

The ability to adapt to new environments, input devices, such as sensors, or to different types of data or models, and to learn or update new machine learning functions would nevertheless be very useful for many systems, including deeply embedded systems. Therefore, it is highly desirable to have flexible solutions that equip embedded systems with the ability to dynamically perform on-device training and other machine learning processes using energy-efficient and storage-efficient systems and methods, for example, to customize a trained model to improve computing and detection accuracy.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 depicts a common deep convolutional neural network having a final classification layer.

FIG. 2 illustrates a neural network topology that is used according to various embodiments of the present disclosure.

FIG. 3 illustrates utilizing a portion of a neural network's storage capacity for back-propagation operations according to various embodiments of the present disclosure.

FIG. 4 shows a conventional back-propagation method in neural network requiring intermediate storage for each stored parameter in every single layer.

FIG. 5 illustrates forward-propagation to the last layer of a neural network according to various embodiments of the present disclosure.

FIG. 6 illustrates forward-propagation to the second-to-last layer of a neural network according to various embodiments of the present disclosure.

FIG. 7 illustrates forward-propagation to the third-to-last layer of a neural network according to various embodiments of the present disclosure.

FIG. 8 is a flowchart of an illustrative process for an iterative back-propagation process in accordance with various embodiments of the present disclosure.

FIG. 9 illustrates forward-propagation to the last layer utilizing a group back-propagation unit according to various embodiments of the present disclosure.

FIG. 10 illustrates forward-propagation to the third-to-last layer utilizing a group back-propagation unit according to various embodiments of the present disclosure.

FIG. 11 is a flowchart of an illustrative process for iterative back-propagation group operations in accordance with various embodiments of the present disclosure.

FIG. 12 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Any headings used herein are for organizational purposes only and shall not be used to limit the scope of the description or the claims. Each reference/document mentioned in this patent document is incorporated by reference herein in its entirety.

Furthermore, it shall be noted that embodiments described herein are given in the context of deep convolutional neural networks, but one skilled in the art shall recognize that the teachings of the present disclosure are not so limited and may equally benefit other neural networks.

In this document the terms “memory” and “memory device” are used interchangeably. Similarly, the terms kernel, weight, filters, coefficients, and activation function may be used interchangeably. “Layer” includes any neural network layer known in the art.

Many common machine learning systems use deep learning techniques such as back-propagation—a process that, in essence, for a small batch of given training examples iteratively distributes an error between predictions and actual ground truth labels back to the parameters of a neural network model to compute gradients of a cost function, such as entropy loss or means-square-error, and modify the parameters in a way such as to reduce the error. This process is typically repeated a number of times while updating parameters by a relatively small and discrete amount each time, e.g., until an acceptable, predetermined error threshold or some other stop condition is achieved to minimize the cost function. In a relatively large, multi-dimensional parameter space, such computations are highly energy and storage intensive, thus, incompatible with existing embedded systems, which are inherently low-capacity devices and, thus, unsuitable for learning through back-propagation.

A major hurdle is that model parameters (e.g., weights) are slightly modified in each round of a back-propagation process, which requires that a copy of those sets of parameters or the information derived therefrom remain available for access and further processing. Under most circumstances, however, this significantly increases (e.g., doubles) parameter storage requirements that existing embedded systems are not designed to handle.

Further, in each round of the back-propagation process, parameters are typically modified only by a relatively small amount, since relative large changes pose the risk of preventing an algorithm from converging. However, when using integer weights, e.g., 8-bits or below, as is typical for embedded systems, parameters can be modified only by discrete amounts, thus, also negatively affecting computational accuracy. Other shortcomings of existing embedded systems include that embedded machine learning accelerators that are designed to perform forward-propagation computations during the inference phase do not support back-propagation operations, which are not used during forward-propagation operations.

Unlike existing deeply embedded systems, various embodiments herein overcome such obstacles while, at the same time, allowing embedded at-the-edge devices to efficiently and dynamically perform machine learning computations over time, advantageously, without requiring excessive amounts of storage and computational resources.

A. Partial/Limited Depth Learning

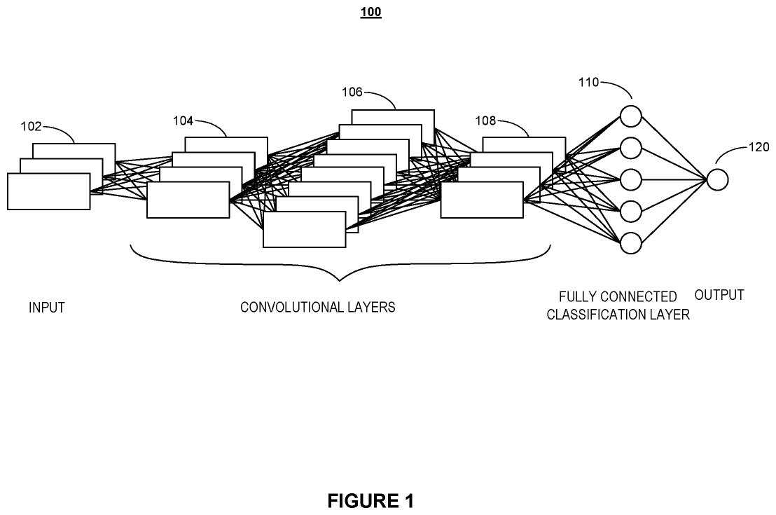

FIG. 1 depicts a common deep convolutional neural network having a final classification layer. Architecture 100 comprises a number of input layers 102, a number of convolutional layers 104-108, a fully connected (classification) layer 110, and output layer 120.

In operation, a neural network like network 100 can perform numerous real-world tasks, such as character recognition, object detection, and other useful tasks. It is noted that the structure of final layer 110 in FIG. 1 differs markedly from the structure of earlier layers since final layer 110 is a single fully connected layer, whereas preceding layers 104-108 are convolutional layers.

Due to the structural differences between hardware accelerators used to process convolutional layers and those used to process a fully connected layer, which typically involves a much greater number of parameters than a convolutional layer, various embodiments herein may augment a fully connected layer with additional storage elements to facilitate back-propagation without the need to also augment convolutional layers with additional storage elements. Examples of additional information that may be stored comprise a local error term or an accumulated error term for a specific node. Advantageously, the increase in storage is thus bounded by the number of fully connected layers, which may be as small as a single layer when compared to the number of convolutional layers, e.g., 128 layers. In embodiments, a learning process may thus affect a fully connected layer without directly affecting other layers in the network. In circumstances in which a small change in behavior or a small adaptation to environmental conditions is desired, such embodiments may be sufficient to achieve the sought after results.

It is understood that not augmenting convolutional layers with additional storage elements is only one exemplary way to achieve the objectives of the present disclosure. As a person of skill in the art will appreciate and as discussed in greater detail below, any number of storage elements may be assigned to certain convolutional layers, e.g., to enable learning in the last n convolutional layers of a neural network.

B. Banked Storage/Capacity Tradeoff

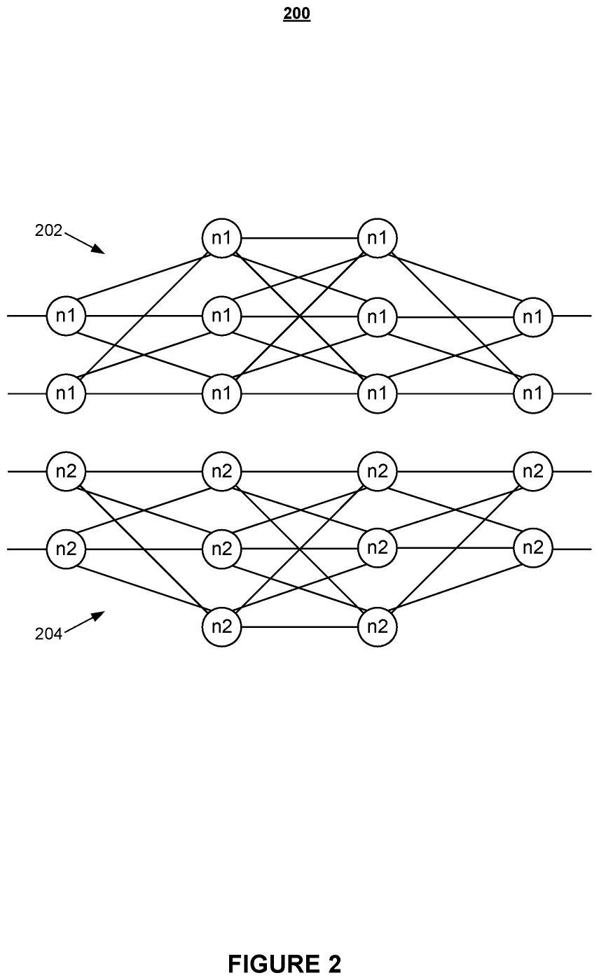

FIG. 2 illustrates a neural network topology that is used according to various embodiments of the present disclosure. As depicted, network 200 comprises sub-networks 202, 204 that may, in embodiments, may be implemented as hardware circuits. In embodiments, since the lack of storage for intermediate parameters is one of the main concerns for on-device learning, network 200 in FIG. 2 may be designed such that, in operation, instead of using the full capacity of network 200 to perform inference operations, e.g., roughly half of the storage capacity of network 200 may be used for inference, e.g., by using sub-network 202, and by using the other half of the storage capacity of network 200 for back-propagation operations by utilizing sub-network 204.

In embodiments, this may be achieved, for example, by remapping half of the storage elements in network 202 from forward-propagation to back-propagation operations. As an example, sub-network 204 may be dedicated to perform training operations instead of inference operations.

Such embodiments are especially useful when a machine learning process lends itself to being separated in two or more portions that each may be mapped to a sub-network. It is noted that, in practice, several applications (e.g., face detection applications) may utilize three or more distinct sub-networks for different tasks. Therefore, in embodiments, a sub-network (e.g., 204) may be individually trained even though its storage capacity for training may be less than the overall storage capacity for inference for network 200.

In embodiments, inference memory may be repurposed for training, e.g., by using banked or mapped memory. Due to their organization, standard memory devices are most space-efficient when being used as tightly packed macros, and they are most timing-efficient when being distributed in a way that equalizes and reduces physical distances from their point of use to the memory cells. This means that the primary concern is the inference operation. In embodiments, adding a second mode, e.g., a back-propagation mode, comprises leaving inference memory in place and adding, e.g., switches or multiplexers, which may couple the inference memory to back-propagation circuitry that facilitates one or more training steps.

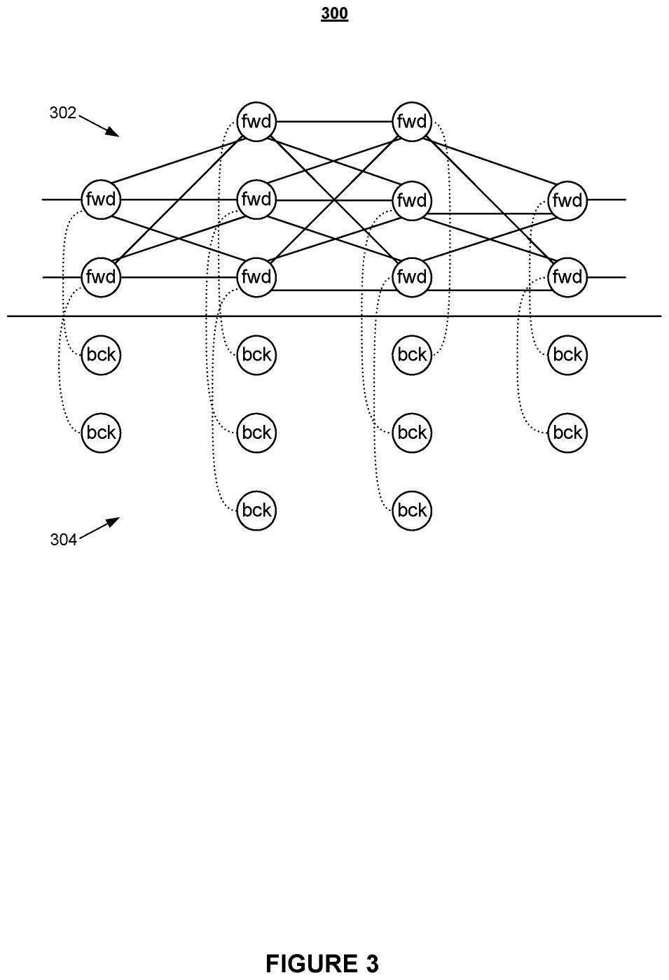

FIG. 3 illustrates utilizing a portion of a neural network's storage capacity for back-propagation operations according to various embodiments of the present disclosure.

Network 300 comprises inference memory 302 that, in operation, performs forward-propagation steps and back-propagation circuit 304 that performs back-propagation steps to enable on-device machine learning. In embodiments, back-propagation circuit 304 may be coupled to inference memory 302 via a switching network (not shown). It is understood that although FIG. 3 illustrates that about 50 percent of the storage capacity of network 300 is used for back-propagation operations, this is not intended as limitation on the scope of the present disclosure.

C. Iterative Back-Propagation

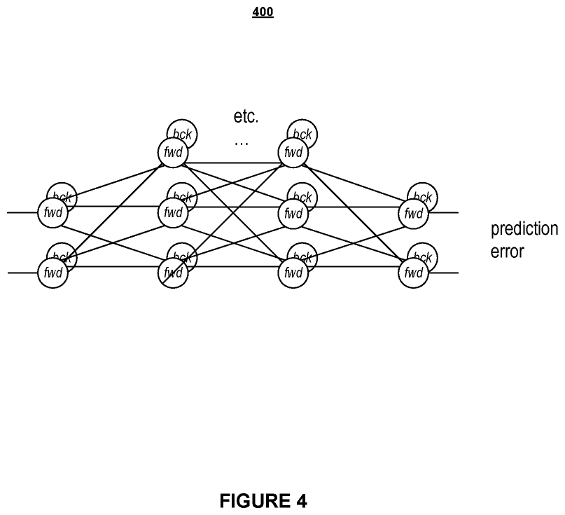

In embodiments, alternative approaches that allow for machine learning in a memory-constrained system may be achieved by using iterative forward-propagation and back-propagation processes that do not require the use of additional storage elements for all parameters and/or for all layer in a neural network. In comparison, conventional back-propagation methods employ a batch-wise back-propagation approach, wherein for each mini-batch of input data one complete back-propagation operation is performed across all neural network layers. However, such conventional back-propagation methods have to rely on the availability of intermediate storage elements in every single layer in a network, such as network 400 in FIG. 4, and for each stored network parameter (e.g., weights).

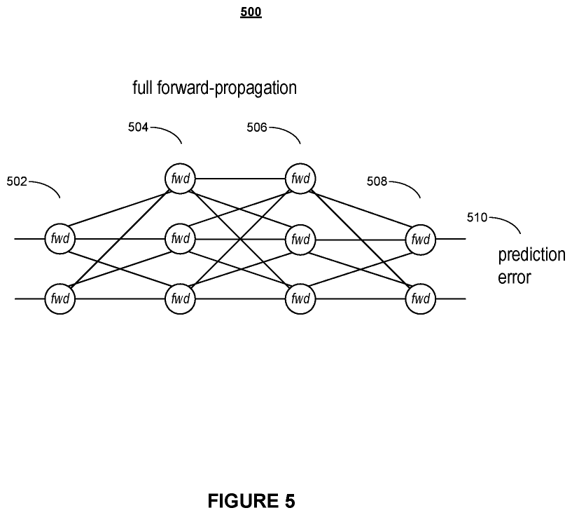

FIG. 5 illustrates forward-propagation to the last layer of a neural network according to various embodiments of the present disclosure. Network 500 comprises four exemplary network layers 502-508, with layer 508 being the last layer and layer 502 being the fourth-to last-layer. In various embodiments, a back-propagation circuit may be modified or used in such a manner as to process a single or layer at a time, e.g., starting at the last layer 502 and iteratively processing layers 504, 506, and so on, to calculate prediction error 510.

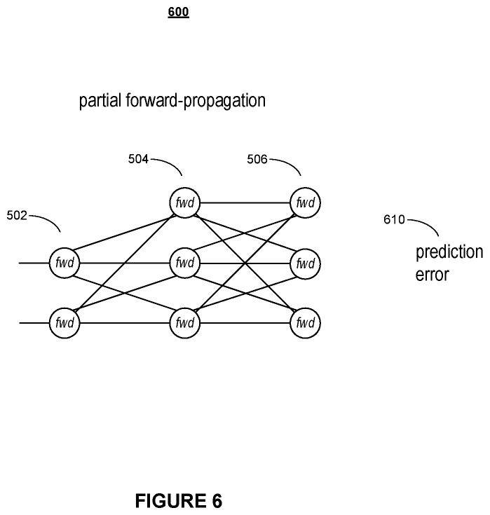

In embodiments, prediction error 510 may then be used to modify parameters in the second to last layer 506, for example, in a forward-propagation to layer 506 as illustrated in FIG. 6, which depicts forward-propagation to the second-to-last layer of neural network 500. In other words, once a back-propagation step is completed, forward-propagation may be repeated using the same batch of input data, such as audio data or image sensor data, and may be allowed to terminate one layer earlier than in the previous forward-propagation step and generate prediction error 610.

In this manner a prediction error at output of each of the processed final layers, e.g., 504-508) may be may be used to modify parameters in the third-to-last layer 504, e.g., in preparation for the next step of back-propagation to, ultimately, to minimize the error.

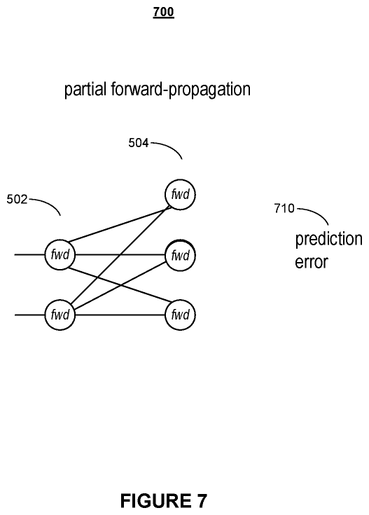

FIG. 7 illustrates forward-propagation to the third-to-last layer of a neural network according to various embodiments of the present disclosure generating prediction error 710. In embodiments, steps may be repeated, e.g., until an entire back-propagation step is complete. Then, the back-propagation process may be repeated for the next batch of input data.

Advantageously, applying back-propagation in only the last few layers is possible in many applications, e.g., in object recognition tasks, recognition of coarse features performed in early layers of a network typically requires less (applications specific) optimization or additional learning. As a result, embodiments presented herein may recreate the type of temporary information that is useful for back-propagation without requiring any additional storage elements that are dedicated exclusively for back-propagation steps.

In various embodiments, hardware may be used to iteratively perform forward-propagation calculations. While performing such repetitive calculations may increase computation time to a certain degree, since the forward-propagation calculations are performed by hardware components this, in effect, reduces storage requirements as the need to store intermediate results is also reduced. Contrariwise, in embodiments, computationally more expensive back-propagation calculations may be performed, e.g., by using a microcontroller or other suitable device that may be located in proximity to the hardware device. Advantageously, repurposing storage elements from inference to training enables additional features in small-scale devices, such as learning about their environment, without significantly increasing hardware requirements and also without requiring excessive computational memory resources when compared with conventional machine learning systems and methods.

It is understood that, in embodiments, once, e.g., an edge device has performed a number of learning steps, it may transition to an inference mode that no longer performs learning. However, this is not intended as a limitation on the scope of the disclosure. As a person of skill in the art will appreciate, a process may transition back to resume with a learning mode, for example, if any of a number of conditions is met, e.g., the lapse of a given amount of time, an internal or external trigger event, such as a user input, an update or calibration request, and so on.

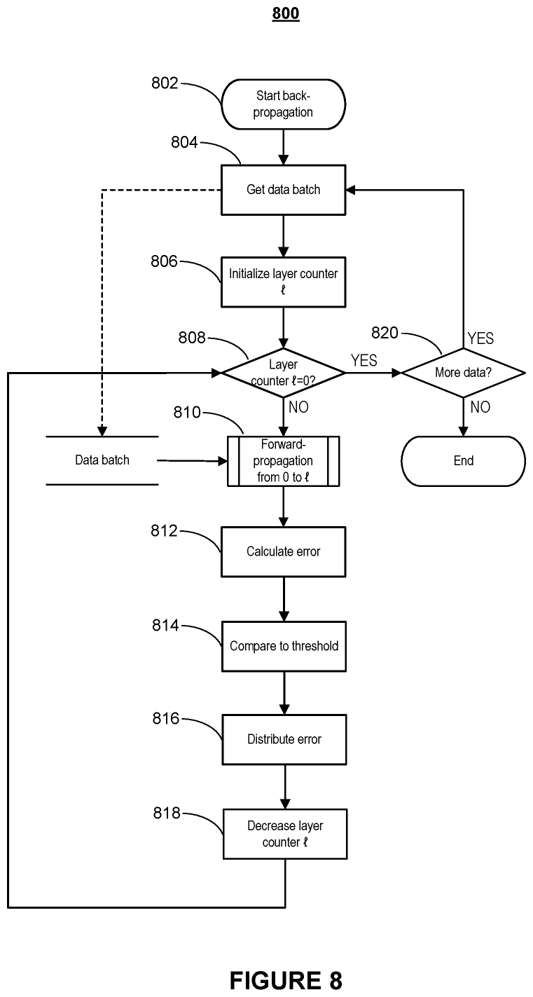

FIG. 8 is a flowchart of an illustrative process for an iterative back-propagation process in accordance with various embodiments of the present disclosure. In embodiments, process 800 may begin at step 802 when a back-propagation step commences.

At step 804, a batch of input data is received, e.g., at a neural network such as a convolutional neural network.

At step 806, a layer counter may be initialized, e.g., to a number “l” that indicates a number of last (or final) layers in the network that will be used for back-propagation operations.

At step 808, it may be determined whether the layer counter has already reached zero, indicating that no more layers in the neural network are available in the present back-propagation step.

If so, process 800 may determine, at step 820, whether another batch of input data is to be processed. And if the decision at step 820 is in the affirmative, process 800 may return to step 804 to resume with receiving the next batch of input data. Otherwise, if the decision at step 820 is negative, process 800 may end.

If, at step 808, if is determined that the layer counter has not yet reached zero, then, process 800 may, at step 810, perform a forward-propagation, e.g., from layer number zero to layer l.

At step 812, an error may be calculated.

At step 814, the error may be compared to some acceptable threshold, e.g., a threshold for a loss function. It is understood that the error may be expressed, e.g., as a predetermined relative value (e.g., a percentage) that provides for a provide a proportional-valued threshold or an absolute value (e.g., a 2-bit-value) that provides for a fixed-valued threshold. It is further understood that an exemplary stop condition may further comprise a number of iterations that are not to be exceeded.

At step 816, the error may be distributed to the previous layer, i.e., layer number l−1, for example, to modify weight parameters in that layer instead of modifying weight parameters in all layers, including those layers all the way back at the beginning of the neural network, as discussed with reference to FIG. 5 through FIG. 7.

Finally, at step 818, the layer counter, l, may be decreased, e.g., to transition to the next back-propagation step that will process the preceding layer, i.e., the next to last layer in the neural network, and so on, until the layer counter has completely counted down to layer l that is to be processed according to various embodiments herein. As in indicated by the dashed line, input data may be processed without reinitializing the layer counter.

One skilled in the art shall recognize that herein: (1) certain steps may optionally be performed; (2) steps may not be limited to the specific order set forth herein; (3) certain steps may be performed in different orders; and (4) certain steps may be done concurrently.

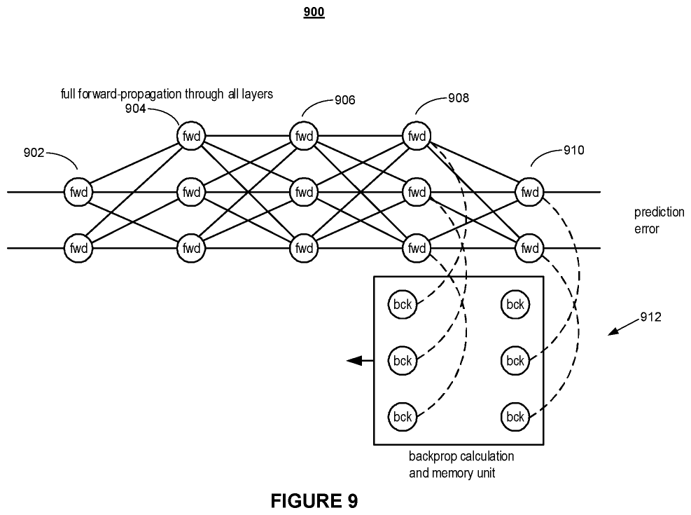

FIG. 9 illustrates forward-propagation to the last layer utilizing a group back-propagation unit according to various embodiments of the present disclosure. Network 900 comprises forward-propagation layers 902-910 and back-propagation and memory unit 912 that, in embodiments, may comprise calculation and memory resources. Back-propagation and memory unit 912 may be implemented as an electrical circuit that enables back-propagation steps and, thus, on-device training that may, at least partially, be performed in hardware.

In embodiments, dedicated storage elements in back-propagation and memory unit 912 may allow back-propagation in more than one of layers 902-910 at a time, e.g., in a group of two or more layers 908 and 910, respectively. In embodiments, back-propagation and memory unit 912 may update parameters for an entire group of layers at a time, for example, starting with the last layer(s) of a neural network, such as layers 908 and 910 in network 900 and working toward the initial layer(s) of the network.

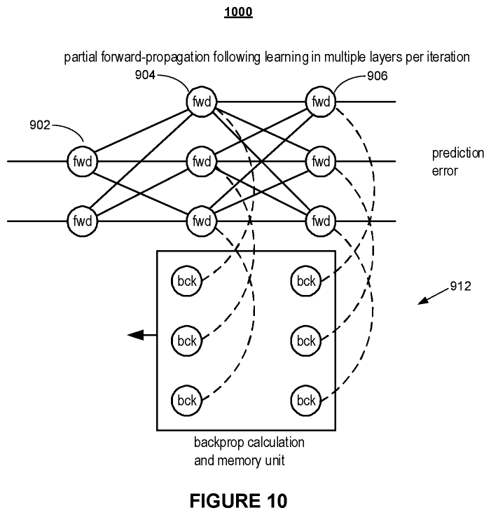

In embodiments, network 900 may be used to repeatedly perform forward-propagation steps by using the same stet of input data (not shown) for each group back-propagation operation, and may terminate forward-propagation at the last layer of a current batch that is to be updated, as illustrated in FIG. 9 and FIG. 10. FIG. 10 illustrates forward-propagation to the third-to-last layer utilizing a group back-propagation unit according to various embodiments of the present disclosure. As depicted, group back-propagation and memory unit 912 may be used to perform forward-propagation in layers 904 and 906 of network 900.

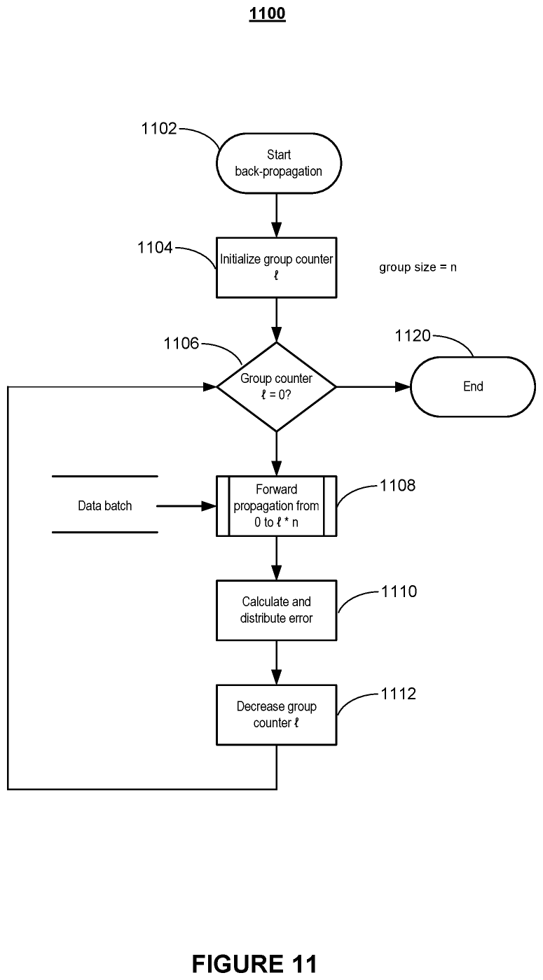

FIG. 11 is a flowchart of an illustrative process for iterative back-propagation group operations in accordance with various embodiments of the present disclosure. In embodiments, back-propagation may begin at step 1102.

At step 1104, a group counter, e.g., for a batch of neural network input data having a group size N, may be initialized, e.g., to a number “1” that indicates a number of last groups in the network that will be used for back-propagation operations.

At step 1106, it may be determined whether the group counter has reached a zero value, indicating that forward-propagation has reached the last group of N layers of the neural network. And if so, process 1100 may end at step 1120.

Otherwise, if it is determined that the group counter has not yet assumed a zero value, process 1100 may, at step 1108, perform forward-propagation, e.g., from layer number zero to layer l*N.

At step 1112, an error may be calculated.

At step 1114, the error may be compared to a threshold or stop condition.

At step 1116, the error may be distributed to the preceding group, e.g., to update weight parameters.

Finally, similar to the process depicted in FIG. 8, the group counter may be decreased at step 1118.

It is understood that, depending on available storage, partial back-propagation according to embodiments herein may be performed in any number of layers of a neural network, e.g., to replace weights in each of a set of final layers. It is further understood that, partial back-propagation according to embodiments herein may be performed at scheduled intervals or as needed.

D. Computational Circuit and Computational Accuracy

In embodiments, adding dedicated memory elements, e.g., back-propagation and memory unit 912, advantageously, permits increasing computational accuracy. It is noted that many existing systems either do not support back-propagation at all, or they are designed to perform back-propagation operations strictly in software. However, from an energy and power consumption perspective, software-implementations are generally known to be inferior to any hardware implementation counterparts.

Therefore, in embodiments, dedicated circuits may be designed to generate gradients and efficiently calculate partial derivatives of complex functions at each network node. For example, a lookup table may be used, and the computation may be performed during forward-propagation. The results may then be stored in the node's additional storage elements previously mentioned, e.g., with reference to FIG. 9. In embodiments, during back-propagation, the calculated terms may then simply be combined to calculate a final parameter change for a given node.

In many cases, the computational accuracy and dynamic range of integers, e.g., 8-bit (or smaller) integers, may be insufficient to adequately perform back-propagation calculations. In embodiments, to mitigate this, relatively larger local copies of parameters may be maintained (e.g., 16-bit fixed-precision numbers or 16-bit floating-point numbers), and dedicated to performing back-propagation operations. In some embodiments, a circuit may automatically copy changes into the standard-accuracy parameter, e.g., converted from higher-precision parameters, e.g., when rounding indicates that the standard-accuracy parameter is affected by a change in value of the higher-precision parameter.

A person of skill in the art will understand that aside from machine learning steps, various tasks, etc., not expressly mentioned herein may be performed by various auxiliary tools (e.g., controllers) in various domains (e.g., analog domain, time domain) to manipulate and process data (e.g., to pre-process input data) to ensure proper configuration and operation of embedded systems such as to obtain the desired results and accuracy.

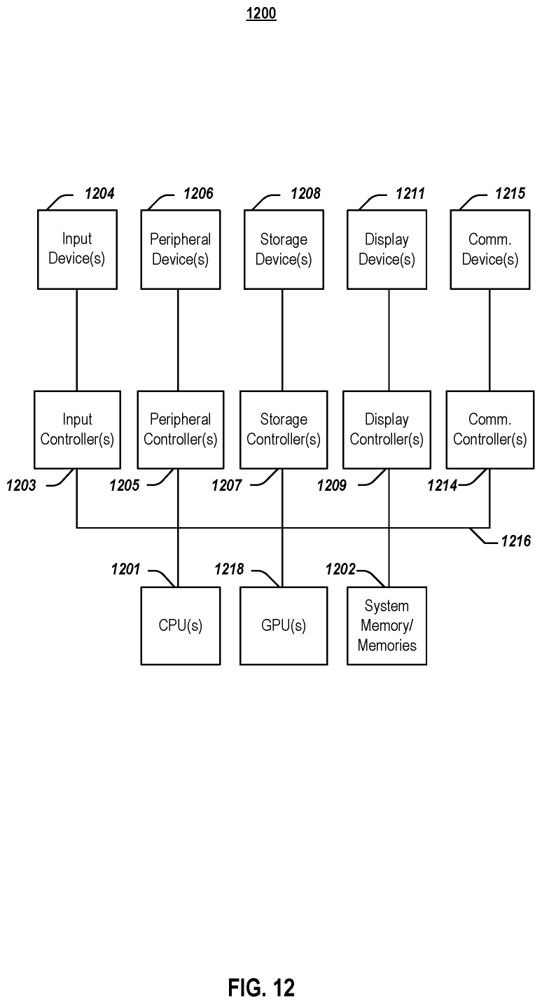

FIG. 12 depicts a simplified block diagram of an information handling system (or computing system) according to embodiments of the present disclosure. It will be understood that the functionalities shown for system 1200 may operate to support various embodiments of a computing system—although it shall be understood that a computing system may be differently configured and include different components, including having fewer or more components as depicted in FIG. 12.

As illustrated in FIG. 12, the computing system 1200 includes one or more central processing units (CPU) 1201 that provides computing resources and controls the computer. CPU 1201 may be implemented with a microcontroller, system microprocessor, or the like, and may also include one or more GPUs 1219 and/or a floating-point coprocessor for mathematical computations. System 1200 may also include a system memory 1202, which may be in the form of random-access memory (RAM), read-only memory (ROM), or both.

A number of controllers and peripheral devices may also be provided, as shown in FIG. 12. An input controller 1203 represents an interface to various input device(s) 1204, such as a keyboard, mouse, touchscreen, and/or stylus. The computing system 1200 may also include a storage controller 1207 for interfacing with one or more storage devices 1208 each of which includes a storage medium such as magnetic tape or disk, or an optical medium that might be used to record programs of instructions for operating systems, utilities, and applications, which may include embodiments of programs that implement various aspects of the present disclosure. Storage device(s) 1208 may also be used to store processed data or data to be processed in accordance with the disclosure. The system 1200 may also include a display controller 1209 for providing an interface to a display device 1211, which may be a cathode ray tube (CRT), a thin film transistor (TFT) display, organic light-emitting diode, electroluminescent panel, plasma panel, or other type of display. The computing system 1200 may also include one or more peripheral controllers or interfaces 1205 for one or more peripherals 1206. Examples of peripherals may include one or more printers, scanners, input devices, output devices, sensors, and the like. A communications controller 1214 may interface with one or more communication devices 1215, which enables the system 1200 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as ASICs, PLDs, flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A storage-efficient method for on-device machine learning, the method comprising:
in a forward-propagation phase of a machine learning process, using storage elements to perform a first forward-propagation in one or more layers in a set of layers of a trained network comprising;
in a back-propagation phase of the machine learning process, using at least some of the storage elements to process a subset of layers in the set of layers in the trained network to at least partially retrain the trained network, the back-propagation phase comprising one or more back-propagation steps that comprise storing intermediate parameters; and
iterating until a stop condition is reached.

2. The method according to claim 1, wherein the subset of layers comprises N final layers in the set of layers.

3. The method according to claim 2, wherein at least partially retraining the trained network comprises replacing weight parameter data in at least some of the N final layers.

4. The method according to claim 3, further comprising using at least some of the weight parameter data to generate an inference result.

5. The method according to claim 1, wherein the first forward-propagation is performed in response to completing at least one of the one or more back-propagation steps.

6. The method according to claim 1, wherein the first forward-propagation commences at an initial layer of the set of layers and terminates prior to a final convolutional layer of the set of layers.

7. The method according to claim 1, further comprising performing a second forward-propagation that terminates earlier than the first forward-propagation by at least one layer in the one or more layers.

8. The method according to claim 1, wherein at least a portion of the storage elements is coupled to a back-propagation circuit.

9. The method according to claim 8, wherein one or more of the storage elements are coupled to the back-propagation circuit via at least one of a set of switches or a set of multiplexers.

10. The method according to claim 1, further comprising, prior to performing the first forward-propagation initializing a layer counter, and decreasing the layer counter after distributing an error.

11. The method according to claim 1, wherein trained network receives a set of input data that comprises at least one of audio data or image sensor data.

12. A storage-efficient system for on-device machine learning, the system comprising:
a processor; and
a non-transitory computer-readable medium comprising instructions that, when executed by the processor, cause steps to be performed, the steps comprising:
in a forward-propagation phase of a machine learning process, using storage elements to perform a first forward-propagation in one or more layers in a set of layers of a trained network comprising;
in a back-propagation phase of the machine learning process, reusing at least some of the storage elements to process a subset of layers in the set of layers in the trained network to at least partially retrain the trained network, the back-propagation phase comprising one or more back-propagation steps that comprise storing intermediate parameters; and
iterating until a stop condition is reached.

13. The system according to claim 12, wherein at least a portion of the storage elements is coupled to a back-propagation circuit.

14. The system according to claim 13, wherein one or more of the storage elements are coupled to the back-propagation circuit via at least one of a set of switches or a set of multiplexers.

15. The system according to claim 12, wherein trained network receives a set of input data that comprises at least one of audio data or image sensor data.

16. A storage-efficient method for on-device machine learning, the method comprising:
receiving a first batch of input data at a neural network;
initializing a layer counter that represents a set of final layers in the neural network;
until stop condition is met, iteratively performing one or more steps comprising:
applying the first batch of input data to a number of layers associated with the layer counter to perform a first forward-propagation;
calculating an error;
comparing the error to a threshold;
distributing the error to a layer that precedes the last of the number of layers; and
decreasing the layer counter; and
resuming with receiving a next batch of input data and initializing the layer counter.

17. The method according to claim 16, further comprising replacing weight parameter data in at least some of the set of final layers.

18. The method according to claim 16, wherein the threshold is at least one of a fixed-valued threshold or a proportional-valued threshold.

19. The method according to claim 16, wherein the layer counter is a group counter is associated with a predetermined group size that represents a subset of the set of final layers in the neural network.

20. The method according to claim 16, further comprising performing a second forward-propagation that terminates earlier than the first forward-propagation by at least one layer in the one or more layers.
